(19) United States
(12) Patent Application Publication
(10) Pub. No.: US 2002/0074188 A1
(43) Pub. Date: Jun. 20, 2002

(54) Installation for transporting people, in particular those with reduced mobility, and fitting of this installation from notably an escalator

(76) Inventor: Marc Lorton, Annecy (FR)

Correspondence Address: HARNESS, DICKEY & PIERCE, P.L.C., P.O. BOX 828, BLOOMFIELD HILLS, MI, 48303, US

(21) Appl. No.: 09/931,652

(22) Filed: Aug. 16, 2001

Related U.S. Application Data
(63) Continuation of application No. PCT/FR00/00385, filed on Feb. 16, 2000.

(30) Foreign Application Priority Data
Feb. 19, 1999 (FR) 99/02114

(51) Int. Cl. B66B 9/08; B61B 9/00

(52) U.S. Cl. 187/201; 187/245

(57) ABSTRACT

An installation for transporting people and/or goods, suitable for transporting people with reduced mobility and people in a wheelchair notably, comprising in combination:

A civil engineering structure and a chassis of the type used for escalators;

At least one cage driven to and fro on a path corresponding to that which would be made by the steps of a complete escalator corresponding to said chassis.

The invention also relates to a method of fitting said installation, in particular from a pre-existing escalator.

The invention relates to an installation for transporting people and/or goods from a first, lower level or landing to at least one second, upper level or landing, an incline separating the two levels.

A number of types of installation of the kind mentioned above are already known in the prior art. A first type of known installation is referred to as a moving staircase or escalator. In moving staircases, platforms or steps, or treads, can be driven continuously, two side enclosures flanking the steps and forming a support for a handrail. Conventionally, the steps are driven by chains, disposed on the sides of said steps, an electric motor such as a synchronous motor being positioned under the lower or upper landing plate, in a technical chamber. The treads conventionally have ribbed step surfaces which pass through combs or combed plates as the steps move along. The steps conventionally carry side rollers running on guide rails positioned in the bottom part of the side enclosures.

Examples of the general structure of escalators can be found in the following documents: FR-2 650 262, EP-A-523 827, EP-A-593 787, EP-A-606 990, EP-A-647 585, EP-A-667 314, EP-A-685 421, EP-A-711 725, EP-A-775 079, EP-A-794 147, WO-A-89/02408, WO-A-91/03417, WO-93/22231, WO-A-95/06612, WO-A-95/09802, WO-A-95/15909, WO-A-95/17342, WO-A-97/00223, WO-97/29987, WO-A-97/31854. Particular characteristics of these escalators can be found in the following other documents:

for the treads: WO-A-92/22491, WO-A-95/23758, EP-A-449 780, EP-A-490 591, EP-A-630 850, EP-A-634 355, EP-A-661 229, EP-A748 291, EP-A-808 792;

for the combed plates: FR-A-2 711 633, EP-A-634 354, EP-A659 676;

for the safety devices:

designed to avoid the jamming or trapping of shoes or clothing in general: EP-A-297 233, EP-A-325 293, EP-A326 689, EP-A-386 512, EP-A-392 819, EP-A-407 759, EPA-523 832, EP-A-594 396, EP-A-603 643, EP-A-716 039, EP-A-739 853, EP-A-801 021, WO-A-97/14644;

designed to detect that a step is absent or sagging or designed to allow an emergency stop: EP-A-307 557, EPA-388 299, EP-A-404 524, EP-A-534 400, EP-A-557 093, EP-A-599 452, EP-A-621 226, WO-A-97/15520, WO-A97/15521, WO-A-95/25061;

for the hand rails: FR-A-2 692 878, European patent application numbers 350 583, 356 782, 385 276, 389 336, 410 746, 420 061, 423 001, 466 666, 484 858, 491 725, 494 403, 503 152, 528 387, 530 944, 530 946, 531 940, 556 964, 575 158, 580 425, 603 993, 605 236, 605 255, 605 256, 608 125, 610 579, 622 325, 622 326, 624 146, 640 553, 644 149, 648 704, 648 705, 655 411, 659 163, 660 800, 661 230, 721 913, 736 478, 780 336, international patent application numbers 91/04219, 93/15015, 94/05584, 94/05585, 97/02204;

for the adaptation of moving staircases to non-rectilinear paths:

French patent application numbers 2 645 136, 2 669 316, 2 738 858;

European patent application numbers 390 629, 390 630, 390 631, 390 632, 412 836, 415 953, 424 209, 436 191, 475 821, 497 877, 662 067, 705 217, 743 921, 811 575;

International patent application numbers 89/10890, 91/06501, 94/07787, 95/10477, 95/21788.

Despite the very many advances made for these escalators, said advances being illustrated notably by the very large number of patents which relate thereto (only some of which are mentioned above, for the most recent), these escalators still have a major drawback, almost intrinsic to their basic principles: only with very great difficulty do they allow the transport of pushchairs, wheelchairs, floor cleaning machines and, in general terms, any person with reduced mobility or any bulky object. Dual function escalators, for wheelchairs, are of course known in the prior art:

the document EP-A-599 556 describes a dual function escalator for a wheelchair comprising a number of specialized steps with a toothed rotor activated on demand;

the document WO-A-92/09519 describes a tread for mounting a wheelchair on three continuous treads. Floating treads are joined to the main treads when a wheelchair is to be mounted;

the document WO-A-97/06091 similarly describes the fitting of additional steps, two or three in number, in a conventional escalator, so as to allow the front or side loading of a wheelchair.

These modified escalators seemed not very user-friendly and complex to use. Furthermore, they provide only an imperfect answer to the problem of very large sized loads such as floor cleaning or other machines, such machines being frequently used in very crowded public places, places in which escalators are themselves also very common. In addition, these modified escalators are most often not accessible to unaccompanied disabled people, and are not generally self-service.

Apart from the escalators mentioned above, there is known in the prior art a second type of installation for transporting people and/or goods over a difference in level: inclined lifts and funiculars. This second type of installation is, in its very principles, totally different from escalators; thus, for example:

cages can be driven by traction cable;

the cages travel to and fro;

the passenger flow is discontinuous.

Inclined lifts and funiculars, unlike escalators, can be practical for transporting disabled people, but also for transporting machines or bulky products. The fitting of such lifts is however expensive and involves considerable civil engineering work notably.

Apart from the two main types of installation for transporting over a difference in level mentioned above, various systems were designed earlier for transporting people with reduced mobility or loads along a staircase:

the document FR-A-2 625 185 describes a goods lift having a carriage running on two parallel rails resting directly on the steps of a staircase, leaving part of these steps free, the carriage being driven by side pinions engaging in racks;

the document FR-A-2 668 439 describes a system similar to the previous one, the rack being immovably attached to a first tube on which there runs a first carriage connected in an articulated manner by means of a connecting rod to a second carriage running on a second tube parallel to the first tube, so that stability of the platform supporting the loads is ensured whatever the slope and change in direction of the parallel tubes;

reference can also be made to the following documents:

for rack goods lifts, associated with a staircase: FRA-269 907, EP-A-458 103, WO-A-97/45354, WO-A-91/08162, EP-A-450 858, WO-A-97/19887;

for cable-driven goods lifts associated with a staircase, including those with suspension of the load: FR-A-2 716 673, FR-A-2 723 578, WO-97/26207, WO-A96/29272, EP-A-700 859, FR-2 726 816;

for chair lifts, or stair gliders: EP-A-560 433, EP-A687 646, EP-A-693 038, EP-A-694 496, EP-A-725 034, EPA-738 232, EP-A-793 614, WO-A-90/08091, WO-A-93/03993, WO-A-94/22757, WO-A-95/18763, WO-A-95/19315, WO-A95/29867, WO-A-96/15974, WO-A-97/19886, WO-A-97/39972.

Cable- or rack-driven goods lifts, associated with a staircase, greatly reduce accessibility to the staircase for able-bodied people and allow only a low passenger flow for people with reduced mobility. Similarly, chair lifts allow only a very low passenger flow, the wheelchair furthermore having to be transported by another route. For this reason, chair lifts are almost exclusively reserved for domestic uses.

The invention relates to an installation for transporting people and/or goods over an incline, allowing safe, fast transporting of people with reduced mobility, pushchairs, or floor cleaning machines for example, the fitting of this installation possibly being carried out from the structure of an existing escalator, without requiring considerable civil engineering work and retaining a large part of the structure of this escalator, and in particular its lateral ground space, the installation operating however in a totally different way from that of an escalator. To that end, the invention relates, according to a first aspect, to an installation for transporting people and/or goods, suitable for transporting people with reduced mobility and people in a wheelchair notably, the installation comprising in combination:

a civil engineering structure and a chassis of the type used for escalators;

at least one cage driven to and fro between at least one bottom station and at least one top station, on a path having at least one rectilinear section corresponding to that which would be made by the steps of a complete escalator corresponding to said chassis.

In one embodiment, the civil engineering structure and the chassis or frame belong to a pre-existing escalator, the steps and handrails of which are removed. In another embodiment, in particular when the traceability of the old frames used is uncertain, a new frame is fitted in place of the escalator frame, in the available volume, without carrying out any route widening work. The installation comprises at least one cable for driving the cage, positioned under this cage along the path of travel thereof. The installation comprises at least one rail for guiding the cage disposed thereunder and along its path of travel between the stations. The means of driving the cage are disposed in a technical chamber similar to that which would be occupied by the driving means of a complete escalator corresponding to said chassis. The complete ground space of the installation can thus be substantially identical to that of a complete escalator corresponding to said chassis. The installation comprises side walls for protecting and covering the route of travel, these walls being assembled with the side enclosures corresponding to those which would form a handrail support for a complete escalator corresponding to said chassis. In another embodiment, the side walls for protecting and covering the route of travel are fixed on the escalator frame. The installation has at least one landing door per cage stopping station, said door preventing access to the route of travel of the cage when said cage is not at the station.

The invention also relates to a method of fitting

an installation such as set out above, said method comprising the steps of:

removal of the steps and treads of an escalator;

removal of the handrails of said escalator;

disconnection of the means of driving the steps with respect to the motor devices;

fitting of the devices for guiding and driving the cage;

fitting of the cage.

The method can also comprise the steps of:

fitting of a landing door at each cage stopping station;

fitting of walls for protection and side covering of the route of travel of the cage.

The protective and covering walls can be assembled in an optionally reversible manner with the side enclosures of the escalator corresponding to the basic chassis of the installation, or be assembled in an optionally reversible manner with the escalator frame, the side enclosures being removed.

Other objects and advantages of the invention will emerge in the course of the following description of one embodiment, said description being given with reference to the accompanying drawings in which:

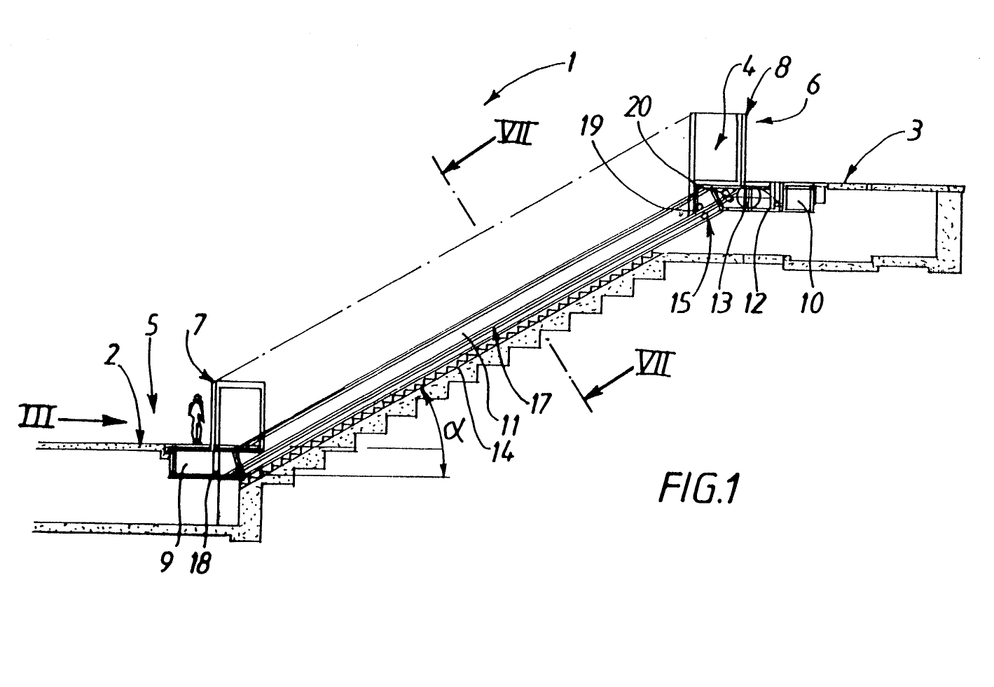

FIG. 1 is a side-face view along an installation according to the invention;

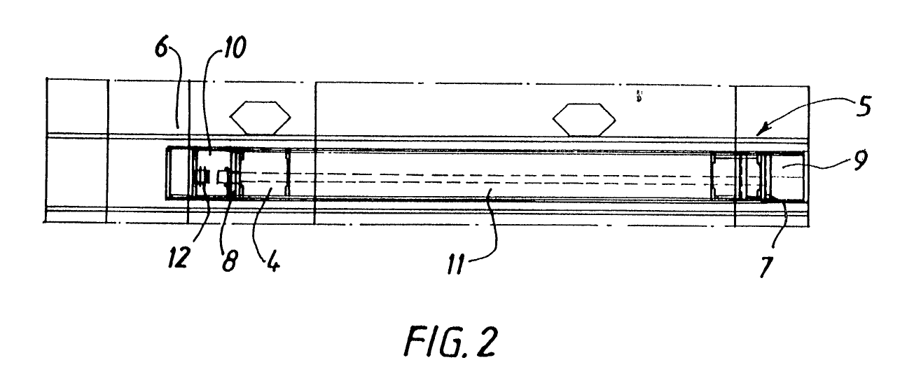

FIG. 2 is a top view corresponding to FIG. 1;

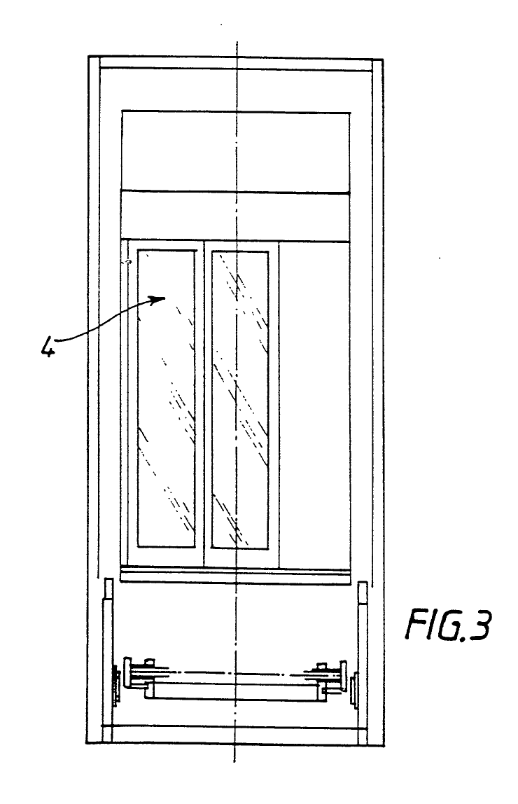

FIG. 3 is a view along the arrow III of FIG. 1;

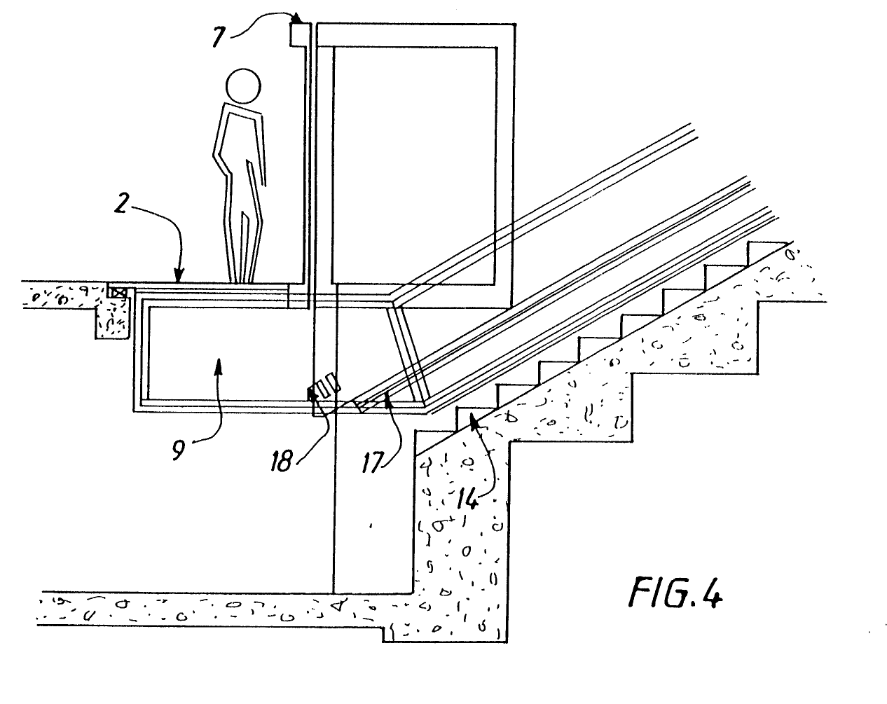

FIG. 4 is a detail view of the bottom station of the installation depicted in FIG. 1;

FIG. 5 is a view similar to FIG. 1, the installation being depicted provided with a covering;

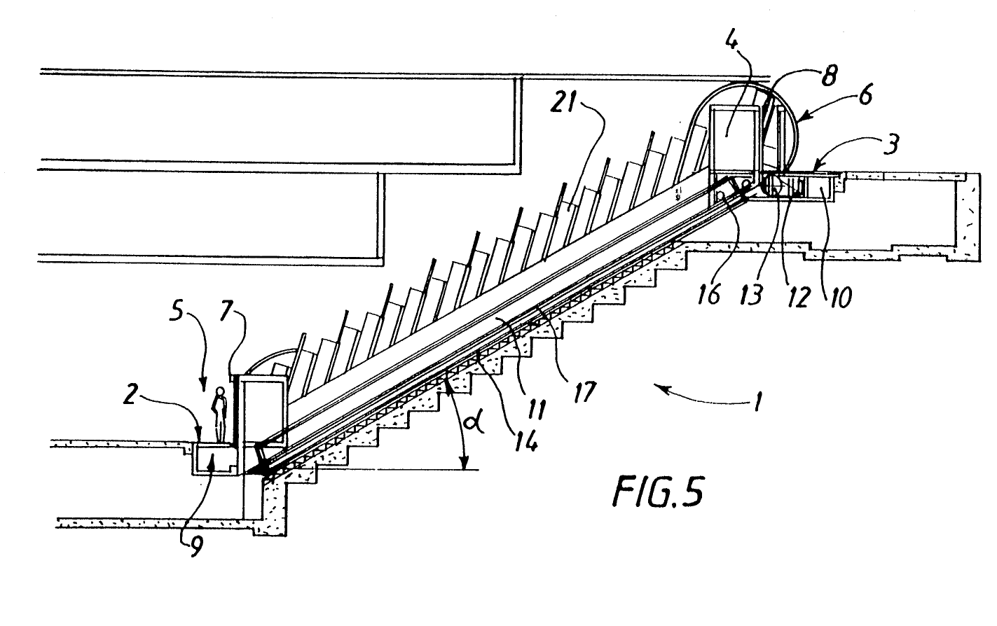

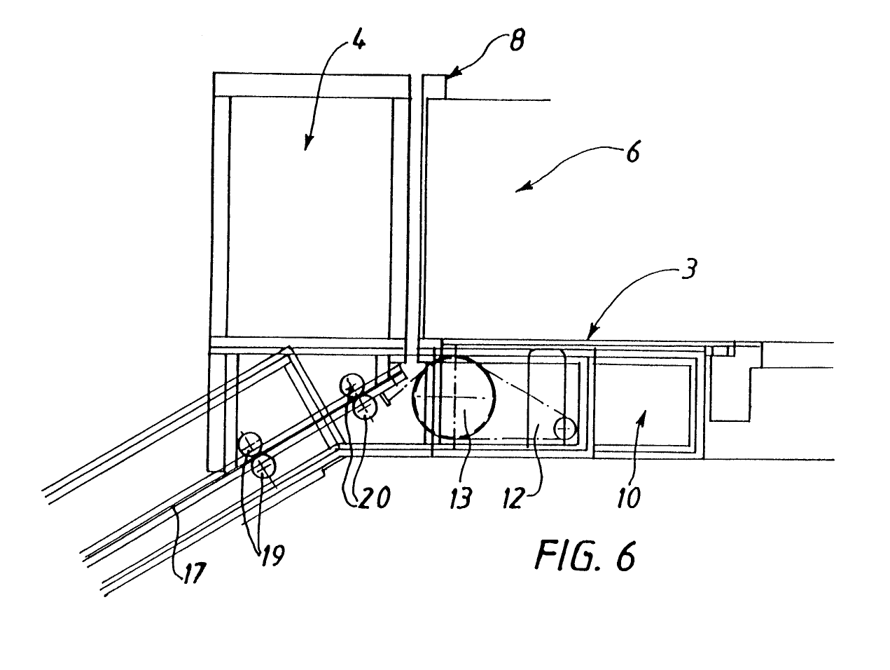

FIG. 6 is a detail view of the top station of the installation depicted in FIG. 1;

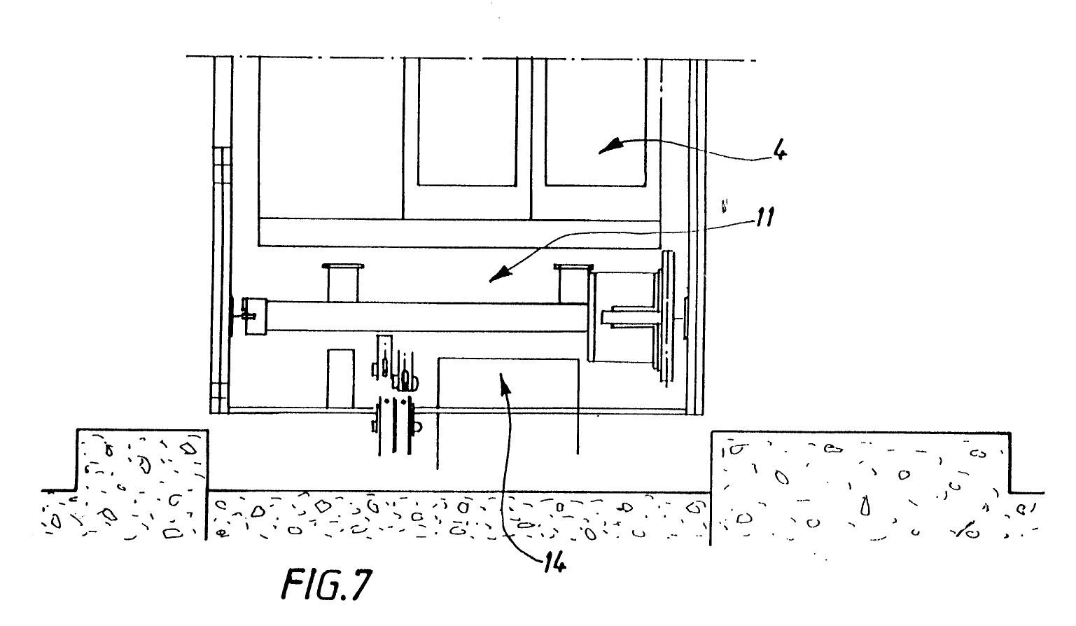

FIG. 7 is a sectional view along the plane VII-VII of FIG. 1;

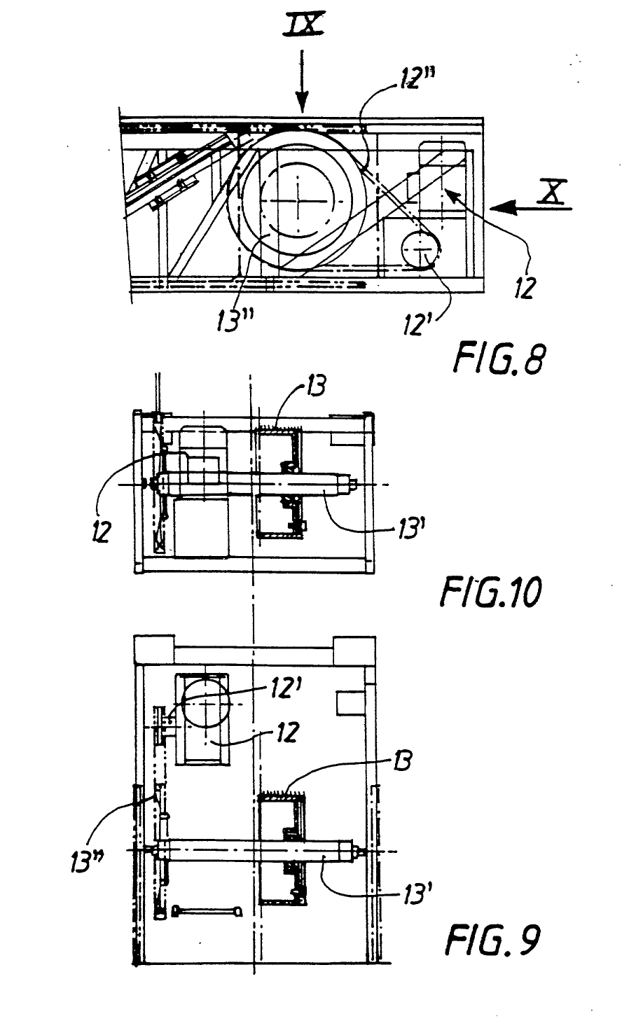

FIG. 8 is a detail view of part of FIG. 6;

FIG. 9 is a top view along the arrow IX of FIG. 8;

FIG. 10 is a side view along the arrow X of FIG. 8.

Reference is made first of all to FIG. 1. The transport installation 1 depicted in FIG. 1 connects a bottom or lower landing 2 to a top or upper landing 3, an incline corresponding to an angle α of around 30° separating the bottom landing 2 from the top landing 3. Solely for information, the installation depicted in FIG. 1 can correspond to:

a difference in height of the order of 9.3 m;

a horizontal length of the order of 16.1 m;

a journey length of the order of 18.6 m.

Unless indicated otherwise, the dimensions which will be mentioned later will correspond to those above, with reference to one possible implementation.

A cage 4 can be driven to and fro from the bottom station 5 to the top station 6. Landing doors 7, 8 prevent access while the cage is not stopped at the top or bottom station, respectively. The chassis of the installation defines:

a bottom technical chamber 9;

a top technical chamber 10;

a path of travel 11 or translational clearance for the cage 4.

The top technical chamber 10 contains the motorization 12 and notably a drum winch 13 or a friction drive pulley. The use of a 45 cm wide drum winch allows a cage journey of around 18 m in the configuration depicted, an 80 cm wide drum enabling a cage journey of around 40 m. The motor, the chain reduction system and the drive shaft on which the drum is fixed can be of the type used in conventional escalators and notably those of the pre-existing escalator before the invention is fitted.

The path of travel 11 is positioned above an emergency staircase 14 allowing access to an optional inspection hatch 15 disposed on the lower face of the chassis of the installation, close to the top technical chamber 10. The emergency staircase allows evacuation of people in the event of malfunction of the installation, as well as maintenance of this installation.

The cage 4 is driven by cable 16 or any other equivalent means, the cage 4 moving by being guided by at least one rail 17. A stop 18 is positioned at the bottom part of the rail 17, the rollers 19 or any other part of the cage 4 possibly resting against this stop when the cage 4 is at the bottom station 5. In the embodiment under consideration, four rollers 19, 20 are associated with the guide rail 17, the inspection hatch 15 being opposite and below the lower rollers 19 when the cage is at the top station 6.

Reference is now made to FIGS. 2 and 3. For information only, the cage 4 can correspond, in the embodiment dimensioned above, to a volume of the order of 1.40×1.4×2.2 (m³), the cage having a substantially square base. Fairly obviously, the cage can have a rectangular base, more deep than wide for example, and be adapted to transporting a number of people with reduced mobility or wheelchairs. The installation, as depicted in FIG. 6, can be provided, on either side of the route of travel of the cage, with protective walls 21, preventing side access to the route of travel, for example from a staircase parallel to the installation 1. These protective walls 21 can be partially or totally transparent or translucent. The general ground space of the installation can be substantially identical to that of an escalator. In addition, advantageously, the installation 1 can be fitted from a pre-existing escalator by re-using the metal chassis of this escalator, without carrying out any civil engineering work, without modifying the location of the motorization, and by removing that which constitutes the heart of the operation of this escalator, namely notably:

the steps and the combs;

the handrails.

The motorization, depicted in FIGS. 8 to 10, can be that of the original escalator. FIG. 8 depicts a geared motor 12 driving, via a substantially horizontal axle 12′, a chain 12″ and a toothed pinion 13″ mounted rotationally on a shaft 13′, the cable for driving the cage 4 being mounted tight on the drum 13. The side enclosures of the escalator can, if applicable, be re-used to serve as a basis for the side covering of the installation 1. If applicable, fitting of the installation on a base common to an escalator can be temporary. In the embodiment under consideration, the installation has a single difference in height. In other embodiments, not depicted, the installation has a number of stretches, with identical differences in height or not, certain stretches possibly being horizontal or substantially flat, or inclined by an angle between a few degrees and 45° with respect to the horizontal.

In the embodiment depicted, the path of the cage 4 is substantially rectilinear. In other embodiments, not depicted, the cage completes paths having at least one curved section, the installation being for example fitted from a curved escalator. In the embodiment under consideration, the motorization is positioned in an identical manner to that encountered in escalators. In other embodiments, not depicted, the cages are self-propelled. In yet other embodiments, the motorization is positioned in a technical room which is not positioned below the top landing.

The installation 1 can be fitted from the structure of an external or internal escalator, or in a ground space corresponding to said escalator. When the differences in level followed by the cage are not constant, an attitude correction device, known per se in the particular technical field of inclined lifts, can be fitted. In the embodiment depicted, passengers and notably people with reduced mobility or people in wheelchairs enter and leave the cage in the same direction as the movement thereof along its path from the bottom station to the top station. In other embodiments, not depicted, passengers enter the cage, for at least one end station and/or at least one intermediate stopping station, by at least one right or left side of the cage. Similarly, passengers can, in certain embodiments, not depicted, leave the cage, for at least one end station and/or at least one intermediate stopping station, by at least one right or left side of the cage. In certain embodiments, not depicted, side access to the cage can be made from a staircase parallel to the installation, for able-bodied people. The cage can then have, besides the front and rear door 22, 23, at least one side door. If applicable, at least two cages can be disposed one behind the other, their floors being at different levels.

The invention claimed is:

1. An installation for transporting people and/or goods, suitable for transporting people with reduced mobility and people in a wheelchair notably, the installation comprising:
(a) a civil engineering structure and a chassis of the type used for escalators having steps; and
(b) at least one cage operably driven to and fro between at least one bottom station and at least one top station, on a path having at least one rectilinear section corresponding to that which would be made by the steps of the complete escalator corresponding to the chassis.

2. An installation according to claim 1, wherein the civil engineering structure and the chassis belong to the pre-existing escalator, the steps and handrails of which are removed.

3. An installation according to claim 1, further comprising at least one cable operably driving the cage, the cable being positioned under this cage along the path of travel thereof.

4. An installation according to claim 1, further comprising at least one rail operably guiding the cage disposed thereunder and along its path of travel between the stations.

5. An installation according to claim 1, further comprising first means for driving the cage is disposed in a technical chamber similar to that which would be occupied by a second means for driving the complete escalator corresponding to the chassis.

6. An installation according to claim 1, wherein the complete ground space is substantially identical to that of the complete escalator corresponding to the chassis.

7. An installation according to claim 1, further comprising side walls operably protecting and covering the route of travel, these walls being assembled with side enclosures corresponding to those which would form a handrail support for the complete escalator corresponding to the chassis.

8. An installation according to claim 1, further comprising at least one landing door per cage stopping station, the door operably preventing access to the route of travel of the cage when the cage is not at the station.

9. An apparatus operable to transport items such as people or goods, the apparatus comprising:
(a) an escalator having steps, a chassis and handrails; and
(b) a cage movably coupled to the chassis after removal of the steps and at least one of the handrails, the cage operably carrying the items from an entry station to an exit station.

10. An apparatus according to claim 9, further comprising a technical chamber located adjacent the chassis and containing a cage propulsion device.

11. An apparatus according to claim 10, wherein the cage propulsion device includes:
a motor;
a rotatable member driven by the motor; and
an elongated member at least partially engaging around and driven by the rotatable member, the elongated member being coupled to move the cage.

12. An apparatus according to claim 9, further comprising a staircase located at least partially below a path of travel of the cage.

13. An apparatus according to claim 9, further comprising a stop positioned at the bottom part of a rail, the rail operably guiding the cage and the stop assisting in stopping the cage adjacent at least one of the stations.

14. An apparatus according to claim 9, further comprising at least four rollers acting with a guide rail to guide the cage.

15. An apparatus according to claim 9, wherein a path of travel of the cage is curved.

16. An apparatus according to claim 9, wherein a path of travel of the cage is rectilinear.

17. An apparatus according to claim 9, wherein the item is a wheelchair.

18. A method of fitting an installation for transporting people and/or goods, the installation having an escalator with steps, treads, handrails and a motorized step driving mechanism, the installation further having a guiding device, a cage driving device and a cage, the method comprising:
(a) removing the steps and treads of the escalator;
(b) removing the handrails of the escalator;
(c) disconnecting the motorized step driving mechanism;
(d) fitting the guiding devices and the cage driving device; and
(e) fitting the cage.

19. A method according to claim 19, further comprising:
(a) fitting a landing door at each cage stopping station; and
(b) fitting walls for protection and side covering of the route of travel of the cage.

20. A method according to claim 18, further comprising assembling the protective and covering walls in a reversible manner with the side enclosures of the escalator corresponding to the basic chassis of the installation.
